(19) United States
(12) Patent Application Publication
(10) Pub. No.: US 2009/0209402 A1
(43) Pub. Date: Aug. 20, 2009

(54) CENTRIFUGAL SEPARATION SYSTEM

(75) Inventor: Lars Andersson, Uppsala (SE)

Correspondence Address: GE HEALTHCARE BIO-SCIENCES CORP.;PATENT DEPARTMENT, 800 CENTENNIAL AVENUE, PISCATAWAY, NJ, 08855, US

(73) Assignee: GE Healthcare Bio-Sciences AB, Uppsala (SE)

(21) Appl. No.: 12/296,982

(22) PCT Filed: Apr. 23, 2007
(86) PCT No.: PCT/SE2007/000388

§ 371 Date: Oct. 13, 2008

(30) Foreign Application Priority Data
Apr. 28, 2006 (GB) 0608451.1

(51) Int. Cl. B04B 11/02

(52) U.S. Cl. 494/6

(57) ABSTRACT

The invention relates to a system, and a set (21) of containers (23, 29, 31, 39, 43) and tubing (53, 57, 65) for use in such a system, for use in a centrifuge for separating components in fluid. The fluid is moved from container to container during centrifugation by pistons (27, 33, 35, 47) provided in the containers. The ratio of mass divided by the cross-sectional area of the container that each piston moves in is different for each piston (27, 33, 35, 47). During centrifugation fluids can be moved from a container having a piston with a high mass to cross-sectional area ratio to a container having a piston with a lower mass to cross-sectional area ratio.

### CROSS-REFERENCE TO RELATED APPLICATIONS

This application is a filing under 35 U.S.C. § 371 and claims priority to international patent application number PCT/SE2007/000388 filed Apr. 23, 2007, published on Nov. 8, 2007, as WO 2007/126357, which claims priority to patent application number 0608451.1 filed in Great Britain on Apr. 28, 2006.

### FIELD OF THE INVENTION

The present invention relates to systems and sets of the types mentioned in the preambles of the independent claims for performing the separation of different density components in fluids

### BACKGROUND OF THE INVENTION

Some fluids, in particular biological fluids such as blood, contain a number of valuable and/or medically or pharmaceutically useful components. Much effort has been expended in finding methods and devices which can efficiently separate and collect such valuable/useful components in relatively pure concentrations. One such way for separating components out of a sample of blood is known from U.S. Pat. No. 6,733,433. This patent describes a system for centrifuging biological fluid in which a sample is placed inside a variable volume cylindrical chamber provided with an axially movable piston. The cylinder is spun rapidly around its longitudinal axis which causes the components in the biological fluid to separate into fractions arranged in concentric rings with the densest fraction nearest the circumference of the chamber and the least dense fraction in the centre of the chamber. The different fraction can be emptied in turn from the chamber though a central opening in the top of the chamber by using compressed air to move the piston towards the top of the chamber. The central opening is connected by a rotary seal to a system of valves, tubes and collection bags to which the different fractions can be directed. An optical sensor on a tube leading from the central opening measures the light absorbance in the tube and the changes in the signal from the optical detector are used by a control device to determine when different fractions pass the optical sensor and to control the valves so that the fractions are directed to the correct collection bag.

### SUMMARY OF THE INVENTION

According to the present invention, systems and sets are provided for separating fluids, particularly biological fluids, into fractions by means of a system having the features present in the characterizing part of claim 1, and a set having the features mentioned in the characterizing part of claim 6.

### BRIEF DESCRIPTION OF THE FIGURES

FIG. 1 shows a schematic plan view of a first embodiment of a centrifuge in accordance with the present invention.

FIG. 2 shows schematically a first embodiment of a disposable set for separating and collecting fractions of biological fluids in accordance with the present invention arranged in a centrifugal chamber.

FIG. 3 shows steps in an embodiment of a method for separating and collecting fractions of blood using the disposable set of FIG. 2.

FIG. 4 shows steps in an embodiment of a method for separating and collecting fractions of blood using the disposable set of FIG. 2.

FIG. 5 shows steps in an embodiment of a method for separating and collecting fractions of blood using the disposable set of FIG. 2.

FIG. 6 shows steps in an embodiment of a method for separating and collecting fractions of blood using the disposable set of FIG. 2.

FIG. 7 shows steps in an embodiment of a method for separating and collecting fractions of blood using the disposable set of FIG. 2.

FIG. 8 shows steps in an embodiment of a method for separating and collecting fractions of blood using the disposable set of FIG. 2.

FIG. 9 shows steps in an embodiment of a method for separating and collecting fractions of blood using the disposable set of FIG. 2.

### DETAILED DESCRIPTION OF THE INVENTION

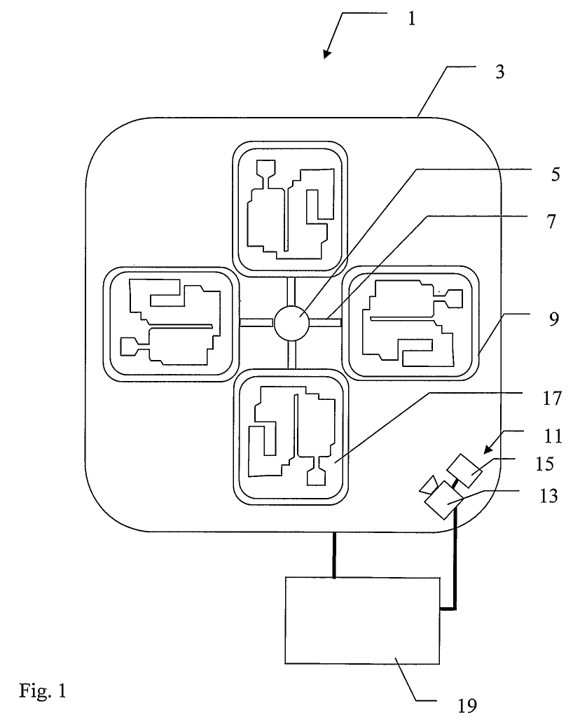

FIG. 1 shows schematically a plan view of a centrifuge 1 in accordance with the present invention in which features well-known to the skilled person have been omitted. Centrifuge has a body 3 which supports a central rotatable shaft 5 to which a plurality, in this case 4, of centrifugal chamber supporting arms 7 are attached. Each arm supports its own centrifugal chamber 9. A imaging device 11, for example a video camera 13 and a high speed camera flash 15 are arranged to image part of the path that a centrifugal chamber 9 follows when being rotated around the central shaft 5 and each centrifugal chamber 9 has transparent wall or window 17 facing towards the imaging device 11. Centrifuge 1 is controllable by a control device 19 such as a microprocessor or a computer which controls the speed of rotation of the centrifuge as well as controlling the flash 15 and valves described below and controlling and processing images from imaging device 11. Flash 15 is controlled so that it illuminates each centrifugal chamber as it passes the same position in the field of view of camera 13 in order to achieve a pseudo-stationary or “still” image of each chamber 9. The connection between the control device 19 and centrifuge 1, valves, imaging device 11 and flash 15 can be through wires and/or it can be wireless, for example by infra red or radio frequency communication.

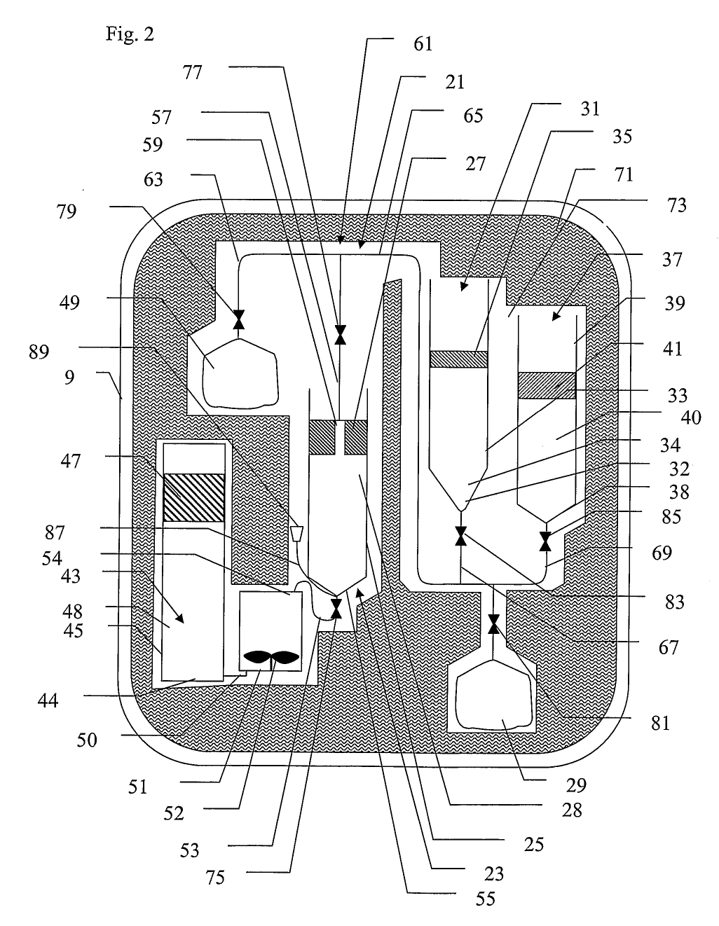

FIG. 2 shows schematically a centrifugal chamber 9 and a set 21 of containers and tubing for separating and collecting components of a biological fluid. Set 21 comprises: a biological fluid-receiving container 23 for receiving the biological fluid to be separated, said container 23 having a cylindrical wall 25 and a bore of cross-sectional area AF containing a movable piston 27 of mass MF in sealing contact with said cylindrical wall 25, the volume of the bore between the piston 27 and the base 55 of container 23 forming a biological fluid receiving cavity 28; a first separated-fraction-receiving container 29 for receiving a separated fraction, said container 29 preferably being in the form of a flexible bag or cylinder of variable volume; an optional separated-fraction-cleaning cylinder 31 having a cylindrical wall 33 and a bore of cross-sectional area AS containing a movable piston 35 of mass MS in sealing contact with said cylindrical wall, the volume of the bore between the piston 35 and the base 32 of container 31 forming a cavity 34 of sufficient volume for receiving a separated fraction and wash buffer; an optional wash buffer containing container 37 having a cylindrical wall 39 and a bore of cross-sectional area AB containing a movable piston 41 of mass MB in sealing contact with said cylindrical wall 39, the volume of the bore between the piston 41 and the base 38 of container 37 forming a cavity 40 for containing a wash buffer; a first additive-containing container 43 having a cylindrical wall 45 and a bore of cross-sectional area AA containing a movable piston 47 of mass MA in sealing contact with said cylindrical wall, the volume of the bore between the piston 47 and the base 44 of container 43 forming a cavity 48 for storing an additive solution; and a second separated-fraction-receiving container 49. Optionally a second additive-containing container 51 may be included in the set arranged so that additive leaving first additive-containing container 43 enters into second additive-containing container 51 through an inlet 50 at or near one end thereof, mixes with the contents of second additive-containing container 51, the mixing being optionally assisted by a mixer 52, and the mixed additive leaves second additive-containing container by an outlet 54 placed at or near the opposite end thereof.

Set 21 further comprises a first, preferably flexible, tubing 53 which connects the base 44 of first additive-containing container 43, (via second additive-containing container 51 if fitted) to the base 55 of fluid-receiving container 23, a second, preferably flexible, tubing 57 which leads from a passage 59 through piston 27 to the leg of a T-junction 61 which leads via a first arm and third, preferably flexible, tubing 63 to second separated-fraction-receiving container 49 and via the second arm and fourth, preferably flexible, tubing 65 to separated-fraction-receiving container 29. If optional separated-fraction-cleaning cylinder 31 and optional wash buffer containing cylinder 37 are presented then their bases 32, respectively 38, are connected to tubing 65 by tubing spur 67 and tubing spur 69 respectively.

Centrifugal chamber 9 has a cavity 71 with preformed depressions 73 adapted to receive and hold in place set 21 in cavity 71 in a predetermined orientation in which the bases of containers 23, 31, 37, 43 are further away from the centre of rotation of the centrifuge than their opposite ends. A first remote controllable valve 75 is positioned to be able to allow or prevent fluid flow through tubing 53. A second remote controllable valve 77 is positioned to be able to allow or prevent fluid flow through tubing 57. A third remote controllable valve 79 is positioned to be able to allow or prevent fluid flow through tubing 63. A fourth remote controllable valve 81 is positioned to be able to allow or prevent fluid flow through tubing 65. A fifth remote controllable valve 83 may be positioned to allow or prevent fluid flow through tubing spur 67. A sixth remote controllable valve 85 may be positioned to allow or prevent fluid flow through tubing spur 69.

In order to allow a volume of biological fluid to be easily introduced into biological fluid-receiving container 23 an inlet line 87 with a preferably sealable inlet port 89 may be provided at any suitable position on the set 21, for example between valve 75 and the biological fluid-receiving container 23 or between valve 77 and the biological fluid-receiving container 23.

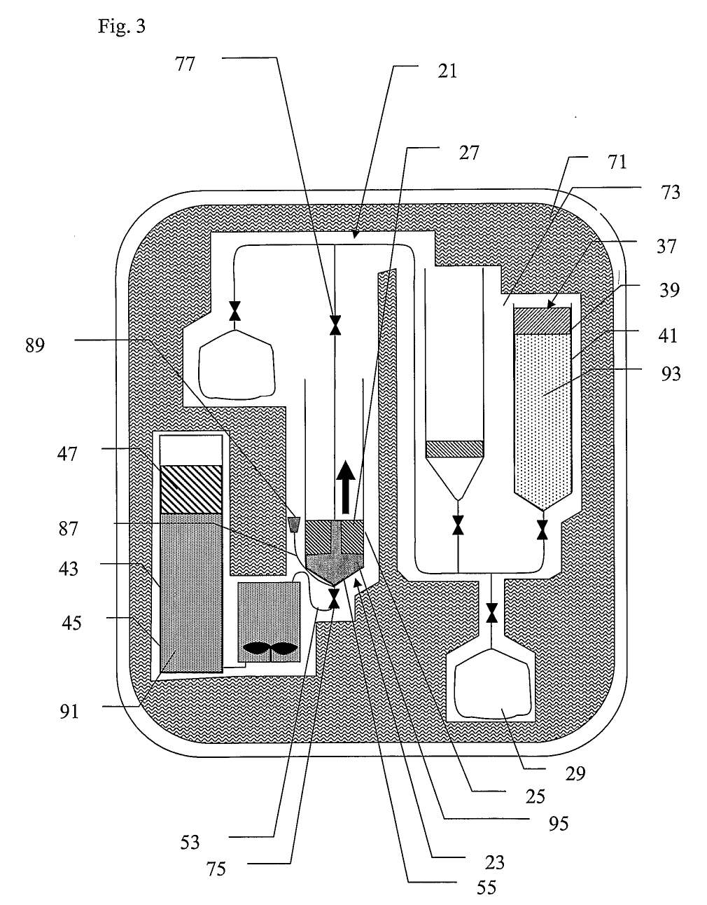

FIGS. 3-9 show steps in an embodiment of a method in accordance with the present invention for separating a predetermined component from a sample of biological fluid using density gradient media 91 as an additive and a wash buffer 93 for washing the predetermined component. In this example the biological fluid is blood 95 and the density of the density gradient media is chosen to be higher than that of mononucleotide cells and less than that of red blood cells in the blood. The first and second additive containers 43, 51 are filled with density gradient media 91 and wash buffer containing container 37 is filled with wash buffer 93. FIG. 3 shows the step of filing biological fluid receiving container 23 with the sample of blood 95 via inlet port 89 and inlet line 87. This is achieved by positioning piston 27 at the base of container 23, closing valves 75 and 77 and injecting the blood sample 95 through inlet port 89 into inlet line 87. The closed valves 75 and 77 prevent the blood sample from entering tubing 53 and 57, which leads to piston 27 being pushed up away from the base 55 of container 23 as blood sample 95 is introduced. The introduction of blood sample 95 into container 23 can take place when the set 21 is inside a centrifugal chamber 9 or more preferably, before being placed into centrifugal chamber 9.

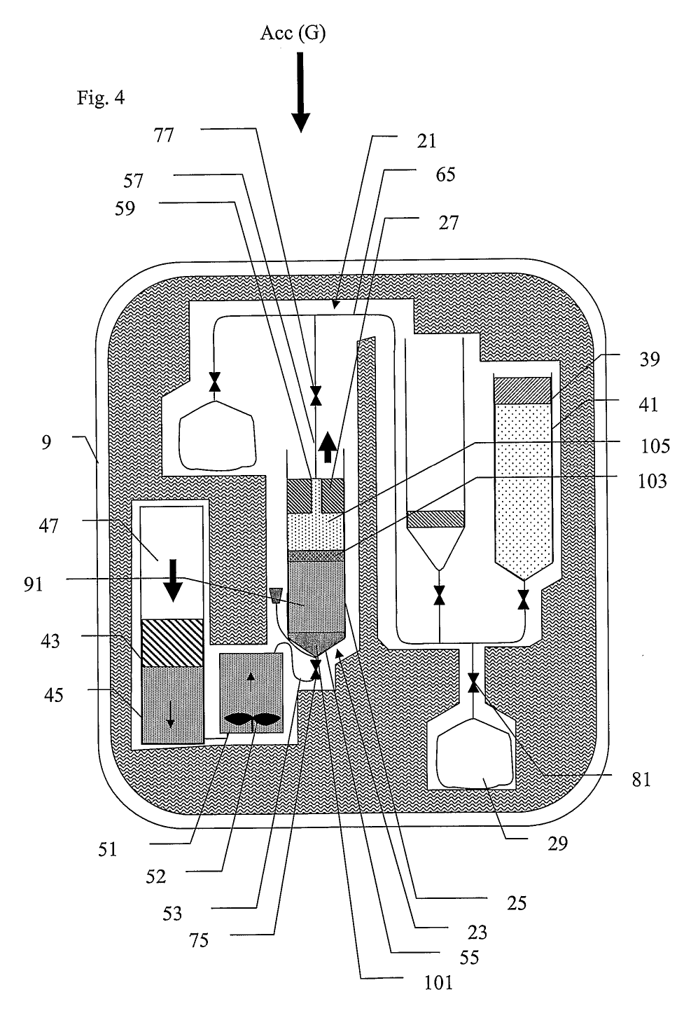

Once blood sample 95 has been introduced and set 21 positioned into centrifugal chamber 9 if it was not already there, centrifugation of the set 21 is begun. The control device causes shaft to rotate at the desired speed and then the density gradient media 91 is added to sample 95. This is achieved by opening valve 75. No pump is need to move the density gradient media 91 from additive container 43 to container 23—this because the ratio of the mass of movable piston 47 over the cross-sectional surface area of container 43 is greater than ratio of the mass of piston 27 over the cross-sectional area of container 23 which cause a pressure differential between the containers which forces the density gradient media 91 into container 23. This flow of density gradient media continues until the pressure differential is equalized or valve 75 is closed. As the centrifugation continues after the flow of density gradient media has ceased the components of the blood sample and the density media move to levels in container 23 which are dependent on their densities and form distinct layers as shown in FIG. 4. In this example, blood sample 95 has been separated in a layer of dense red blood cells 101, above which is a layer of density gradient media 91. A layer of mononucleotide cells 103 lies above the density gradient media 91 and a further layer of less dense blood plasma 105 lies above the layer of mononucleotide cells 103.

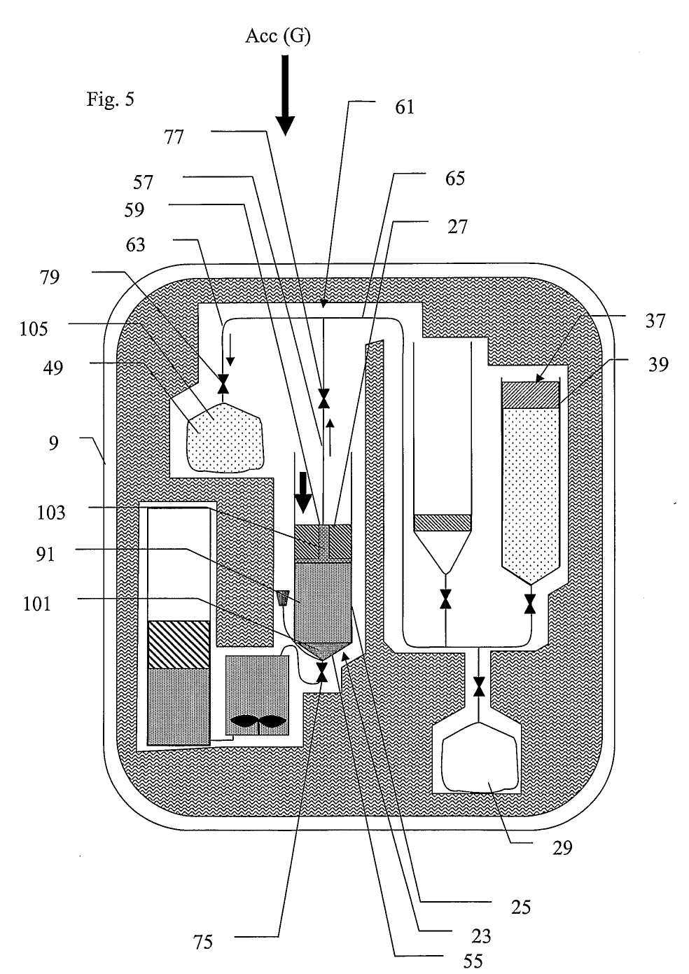

Control device 19 can be provided with software for image processing and by processing the picture signal from imaging device 11 it can identify when the components have separated into substantially stable layers. Once substantially stable layers have been identified (or after a predetermined time since the start of centrifugation has elapsed), control device 19 commands valves 77 and 79 to open. This allows piston 27 to move towards the base of container 23 under the force Acc generated by the rotation of centrifugal chamber 9 which causes the fluid in container 23 nearest to piston 27, blood plasma 105, to leave the container 23 via passage 59. The blood plasma 105 passes along tubing 57, though valve 77, along tubing 63 to second separated-fraction-receiving container 49. Once all the blood plasma 105 has left container 23, the mononucleotide cells 103 start to leave container 23 via passage 59 as shown in FIG. 5.

Control device 19 is preferably provided with software which can calculate the rate of flow of blood plasma through tubing 57 by measuring the speed of displacement of piston 27 and using the known volume per unit length of tubing 57. It can calculate when the last of the blood plasma 105 and the first of the mononucleotide cells 103 will reach T-junction 61 and can command valve 79 to close and valve 83 to open at this time (or shortly before this time to ensure the maximum yield of mononucleotide cells 103 by avoiding the risk that some mononucleotide cells 103 enter tubing 63).

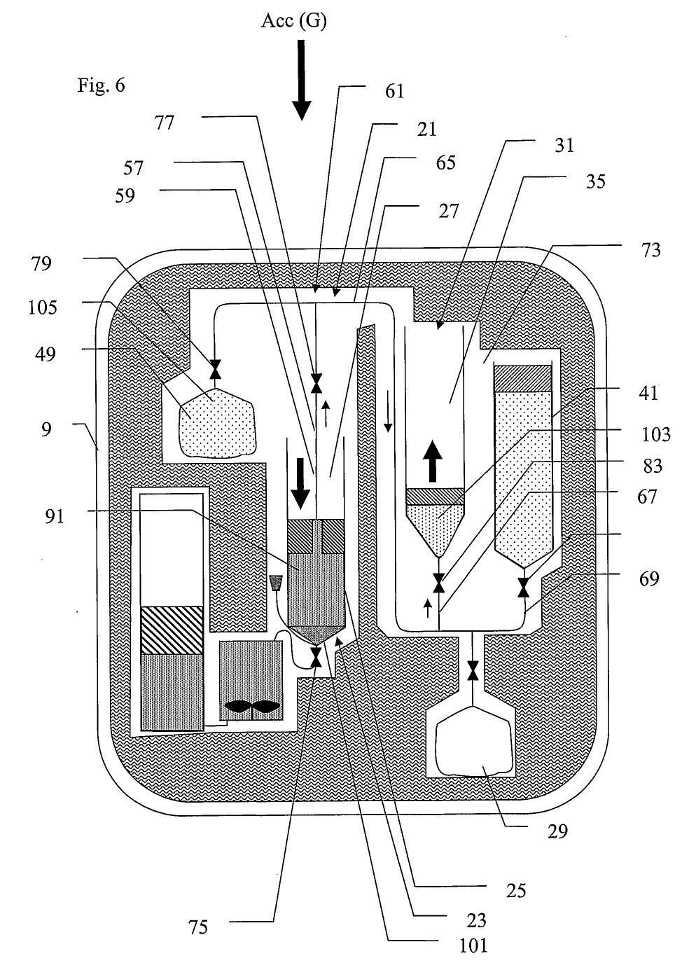

In this embodiment of a method according to the present invention it is desired to clean the mononucleotide cells 103 before collecting in separated-fraction-receiving container 29 then once valve 79 is closed valve 81 is kept closed and the valve 83 is opened. This causes the mononucleotide cells 103 to flow into separated-fraction-cleaning container 31 via tubing 65 and tubing spur 67 as shown in FIG. 6. As the ratio of piston mass over container cross-sectional area of container 31 is less than that of container 23, this flow occurs without the aid of any pump. Control device 19 is preferably provided with software which can calculate the rate of flow of density gradient media 91 through tubing 57 by measuring the speed of displacement of piston 27 and using the known volume per unit length of tubing 57. It can calculate the time when the last of the mononucleotide cells 103 and the first of the density gradient media 91 will reach valve tubing spur 67 and can command valves 77 and 83 to close at this time (or shortly before this time) to prevent any density gradient media 91 passing into tubing spur 67 into separated-fraction-cleaning container 31.

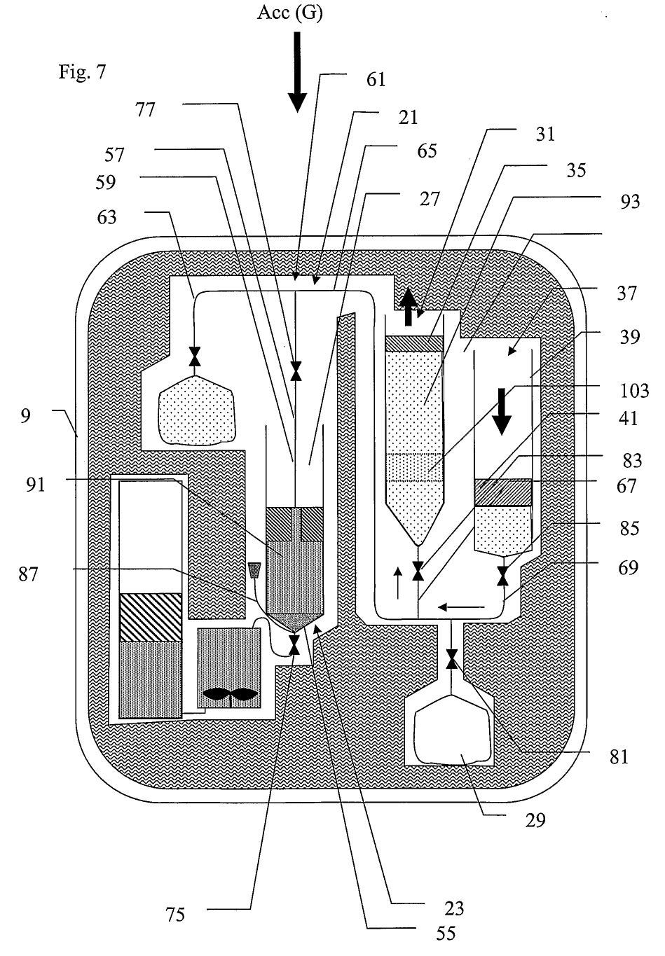

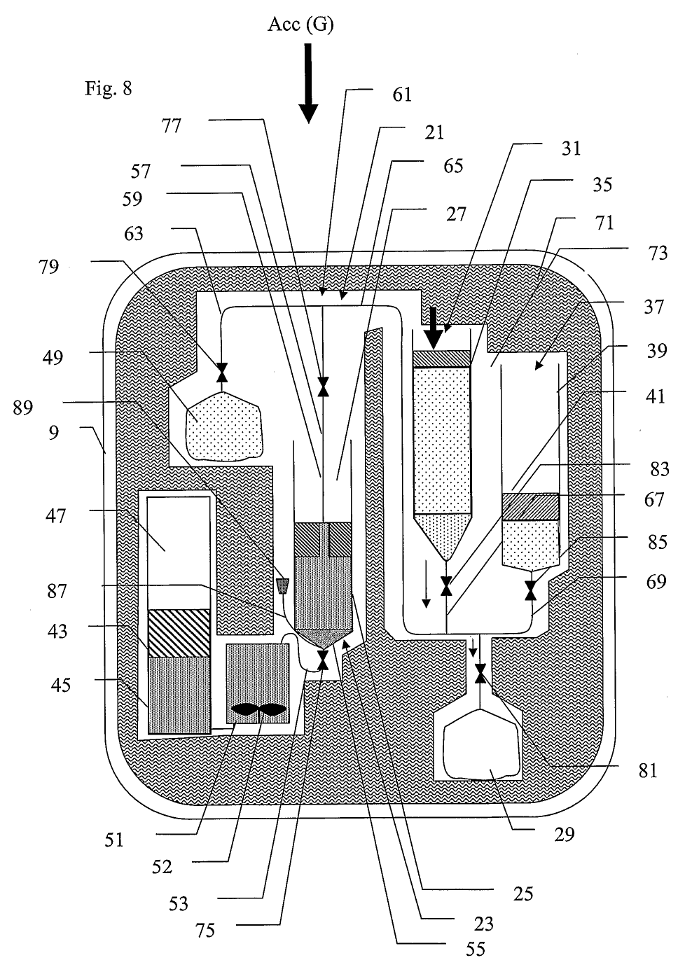

The mononucleotide cells 103 can be cleaned in separated-fraction-cleaning container 31 by opening fifth remote controllable valve 83 and sixth remote controllable valve 85. As the ratio of the mass of movable piston 41 over the cross-sectional surface area of container 37 is greater than ratio of the mass of piston 35 over the cross-sectional area of container 31 a pressure differential is formed between the containers 31, 37 which forces the wash buffer 93 from container 37 into container 31 until an equilibrium is reached. Wash buffer 93 is preferably selected to have a specific density which is less than that of the mononucleotide blood cells 103. This flow of wash buffer 93 into container 31 lifts the mononucleotide cells 103 from the base 32 of container 31 and if the speed of the incoming wash buffer 93 is sufficiently high it suspends them in the flow of incoming wash buffer 93 at a distance from the base 32. As shown in FIG. 7 they remain suspended as incoming wash buffer 93 flows through the layer of mononucleotide cells 103, thereby washing them in a process called “elutriation”. After a predetermined time or after a predetermined volume of wash buffer 93 has entered container 31 or once piston 35 has reached a predetermined position, valves 83 and 85 are closed. This allows the mononucleotide cells 103 to collect at the base of container 31 as shown in FIG. 8.

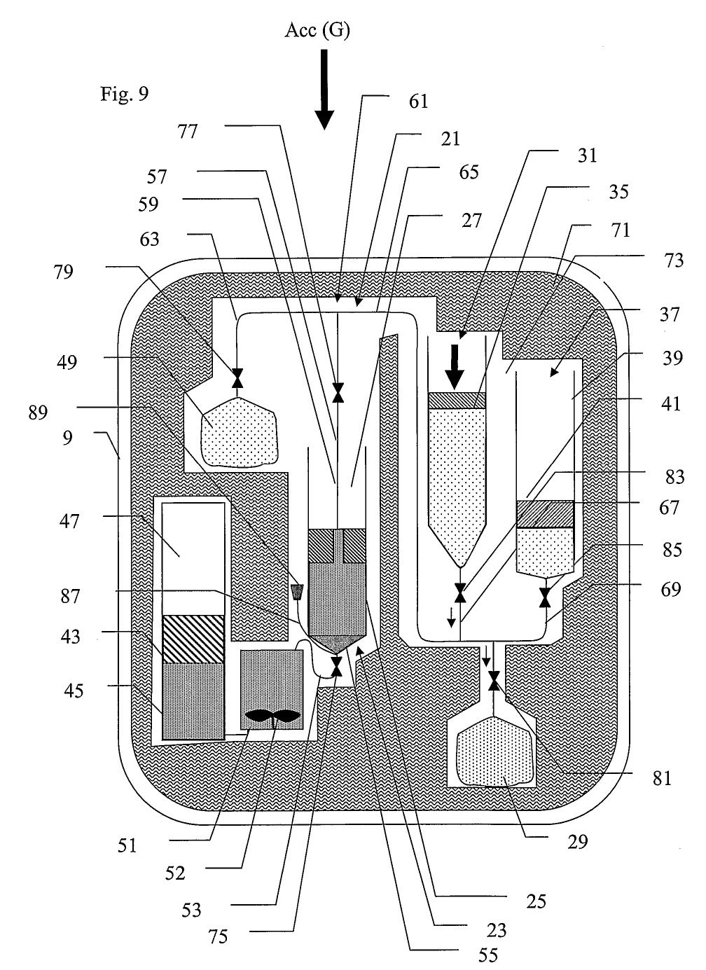

The mononucleotide cells 103 can be transferred to first separated-fraction-receiving container 29 by opening valves 81 and 83. This allows the force exerted by piston 35 on the contents of container 31 to push the mononucleotide cells 103 through tubing spur 67 and tubing 65 via valves 81 and 83 into first separated-fraction-receiving container 29 as shown in FIG. 9. Control device 19 is preferably provided with software which can calculate the rate of flow of mononucleotide cells 103 through tubing 65 and 67 by measuring the speed of displacement of piston 35 and using the known volume per unit length of tubing 65 and 67. It can calculate the time when the last of the mononucleotide cells 103 and the first of the wash buffer 93 will reach valve 81 and can command valves 81 and 83 to close at this time (or shortly before this time) to prevent any wash buffer 93 from valve 81 and into separated-fraction-receiving container 29. The centrifuge can then be stopped and the set 21 remove from the centrifuge chamber 9 for further processing.

In a second embodiment of a method in accordance with the present invention it is desired to collect the mononucleotide cells 103 without cleaning. This second embodiment of a method is the same as the first embodiment of a method in accordance with the present invention (except that it is no longer necessary to provide wash buffer in container wash buffer containing container 37) up to the point when blood plasma is contained in second fraction container 49 and valve 79 has been closed. Once valve 79 is closed, in the second embodiment of a method in accordance with the present invention valve 81 is opened and the mononucleotide cells 103 flow though tubing 65 into first separated-fraction-receiving container 29 due to the force that piston 27 exerts on the contents of container 23. Once all the mononucleotide cells 103 have left container 23, the density gradient media 91 starts to leave container 23 via passage 59. Control device 19 is preferably provided with software which can calculate the rate of flow of density gradient media 91 through tubing 57 by measuring the speed of displacement of piston 27 and using the known volume per unit length of tubing 57. It can calculate the time when the last of the mononucleotide cells 103 and the first of the density gradient media 91 will reach valve 81 and can command valve 81 to close at this time (or shortly before this time) to prevent any density gradient media 91 passing through valve 81 into first separated-fraction-receiving container 29. The centrifuge can then be stopped and the set 21 remove from the centrifuge chamber 9 for further processing.

In the embodiments of the present invention described above only one type of density gradient media was employed and this formed a layer between components of the biological sample having a density greater than the density gradient media and components having a density less than the density gradient media. Often it is desirable to separate a biological fluid into more than two fractions separated by a layer of density gradient media and this requires the use of more than one density of density gradient media. Preferably this is achieved by mixing together, in varying proportions two density gradient media having different densities—the denser having a original density A and the less dense having a density B—either to form a substantially continuous gradient of gradient density media (where the density ranges from A to B) or, by mixing predetermined proportions of each of the original density gradient media (e.g. 10% A plus 90% B, 50% A plus 50% B, etc), to achieve a number of intermediate-density density gradient media having densities lying between the density of the denser original gradient density medium A and the least dense original density gradient medium B.

In a third embodiment of a method in accordance with the present invention, it is desired to use a continuous gradient of density gradient media. This method differs from the methods of the first and second embodiments of the previous invention by starting with a first, preferably densest gradient density medium A in first additive container 43 and a second least dense gradient density medium B in second additive container 51. A gradient of density gradient media is achieved by actuating mixer 52 and opening valve 73. Opening valve 73 allows density gradient medium A to flow from first additive container 43 into second additive container 51 where it is mixed by mixer 52 with density gradient medium B to form a intermediate-density density gradient medium with a density between A and B. As the intermediate-density density gradient medium leaves second additive container 51 and flows into biological fluid-receiving container 23 the proportion of density gradient medium A to density medium B in second additive container 51 increases and the density of the intermediate-density gradient density medium leaving second additive container 51 increases as well. This leads to a gradient of increasing density intermediate-density density gradient media being introduced into biological fluid-receiving container 23. Once the desired volume of density gradient media has been introduced into biological fluid-receiving container 23 then mixer 52 is deactivated and valve 75 closed. The method then continues in a similar fashion to the method previously described, the main difference between the methods being that if the correct density gradient media gradient has been achieved then the target component(s) of the biological fluid will be separated into more layers, with a layer of density gradient media separating these layers.

The above examples illustrate specific aspects of the present invention and are not intended to limit the scope thereof in any respect and should not be so construed. Those skilled in the art having the benefit of the teachings of the present invention as set forth above, can effect numerous modifications thereto. These modifications are to be construed as being encompassed within the scope of the present invention as set forth in the appended claims.

1: A system for the processing and separation of fluids into fractions, comprising:
a fluid-receiving container (23) for receiving the fluid to be separated said fluid-receiving container (23) having a cylindrical wall (25) and a bore of cross-sectional area AF;
a first separated-fraction-receiving container (29) for receiving a separated fluid component;
a first additive-containing container (43) for storing an additive solution, said first additive-containing container (43) having a cylindrical wall (45) and a bore of cross-sectional area AA;
a centrifuge (1) comprising at least one centrifugal chamber (9) for receiving and holding said containers (23, 43) each with their longitudinal axis pointing towards the centre of rotation of said centrifuge (1);
a first tubing (53) and a first valve (75) for establishing selective communication between said fluid-receiving container (23) and said at least one additive-containing container (43);
a second tubing (57, 65) and at least one second valve (77, 81) for establishing selective communication between said fluid-receiving container (23) and said at least one separated-fraction-receiving container (29);
an imaging means (11) for imaging said containers (23, 29, 43) during operation of said system and producing a signal representing the imaging of said containers;
a control means (19) to receive and interpret said signal and further able to control operation of said centrifuge (1) and said first and second valves (75, 77, 81) in order to control the flow of fluids in said system;
wherein said fluid-receiving container (23) is provided with a movable piston (27) of mass MF in sealing contact with said cylindrical wall (25), said piston (27) being provided with a through passage (59) connecting a fluid-receiving cavity (28) of said fluid-receiving container (23) with tubing (57, 65) and said at least one valve (77, 81) for establishing selective communication between said fluid-receiving container (23) and said at least one separated-fraction-receiving container (29); and,
said first additive-containing container (43) is provided with a movable piston (47) of mass MA in sealing contact with said cylindrical wall (45),
wherein the ratio of piston mass MA divided by the cross-sectional area AA of the bore for said first additive-containing container (43) is greater than the ratio of piston mass MF divided by the cross-sectional area of the bore AF for the fluid-receiving container (23).

2: The system of claim 1 further comprising at least one further additive-containing container (51) arranged in fluid communication between said first additive-containing container (43) and said fluid-receiving container (23).

3: The system of claim 2, wherein at least one of said at least one additive-containing containers (51) is provided with a mixer (52).

4: The system of claim 1, further comprising a second separated-fraction-receiving container (49) selectively connectable to fluid receiving cavity (28).

5: The system of claim 1 further comprising a separated-fraction-cleaning cylinder (31) having a cylindrical wall (33) and a bore of cross-sectional area AS containing a movable piston (35) of mass MS in sealing contact with said cylindrical wall, the volume of the bore between the piston (35) and the base (32) of container (31) forming a cavity (34) and a wash buffer containing container (37) having a cylindrical wall (39) and a bore of cross-sectional area AB containing a movable piston (41) of mass MB in sealing contact with said cylindrical wall (39), the volume of the bore between the piston (41) and the base (38) of container (37) forming a cavity (40), wherein the ratio of piston mass MB divided by the cross-sectional area AB of the bore for said wash buffer containing container (37) is greater than the ratio of piston mass MS divided by the cross-sectional area of the bore AS for the separated-fraction-cleaning container (31);
and the ratio of piston mass MF divided by the cross-sectional area AF of the bore for said fluid-receiving container (23) is greater than the ratio of piston mass MS divided by the cross-sectional area of the bore AS for the separated-fraction-cleaning container (31).

6: A set (21) for collecting fractions of a fluid comprising
a fluid-receiving container (23) for receiving the fluid to be separated said fluid-receiving container (23) having a cylindrical wall (25) and a bore of cross-sectional area AF;
a first separated-fraction-receiving container (29) for receiving a separated fluid component;
a first tubing (53) and first valve (75) for establishing selective communication between said fluid-receiving container (23) and said at least one additive-containing container (43);
a second tubing (57, 65) and at least one second valve (77, 81) for establishing selective communication between said fluid-receiving container (23) and said at least one separated-fraction-receiving container (29);
wherein said fluid-receiving container (23) is provided with a movable piston (27) of mass MF in sealing contact with said cylindrical wall (25), said piston (27) being provided with a through passage (59) connecting a fluid-receiving cavity (28) of said fluid-receiving container (23) with tubing (57, 65) and said at least one second valve (77, 81) for establishing selective communication between said fluid-receiving container (23) and said at least one separated-fraction-receiving container (29); and,
said first additive-containing container (43) is provided with a movable piston (47) of mass MA in sealing contact with said cylindrical wall (45),
wherein the ratio of piston mass MA divided by the cross-sectional area AA of the bore for said first additive-containing container (43) is greater than the ratio of piston mass MF divided by the cross-sectional area of the bore AF for the fluid-receiving container (23).

7: The set of claim 6, further comprising at least one further additive-containing container (51) arranged in fluid communication between said first additive-containing container (43) and said fluid-receiving container (23).

8: The set of claim 6, wherein at least one of said at least one additive-containing containers (51) is provided with a mixer (52).

9: The set of claim 6 further comprising a second separated-fraction-receiving container (49) selectively connectable to fluid receiving cavity (28).

10: The set of claim 6 further comprising a separated-fraction-cleaning cylinder (31) having a cylindrical wall (33) and a bore of cross-sectional area AS containing a movable piston (35) of mass MS in sealing contact with said cylindrical wall, the volume of the bore between the piston (35) and the base (32) of container (31) forming a cavity (34) and a wash buffer containing container (37) having a cylindrical wall (39) and a bore of cross-sectional area AB containing a movable piston (41) of mass MB in sealing contact with said cylindrical wall (39), the volume of the bore between the piston (41) and the base (38) of container (37) forming a cavity (40), wherein the ratio of piston mass MB divided by the cross-sectional area AB of the bore for said wash buffer containing container (37) is greater than the ratio of piston mass MS divided by the cross-sectional area of the bore AS for the separated-fraction-cleaning container (31); and the ratio of piston mass MF divided by the cross-sectional area AF of the bore for said fluid-receiving container (23) is greater than the ratio of piston mass MS divided by the cross-sectional area of the bore AS for the separated-fraction-cleaning container (31).
